(19) United States
(12) Patent Application Publication
(10) Pub. No.: US 2025/0261621 A1
(43) Pub. Date: Aug. 21, 2025

(54) HOVERING, STROLLING FISHING RIG

(71) Applicant: Core Tackle LLC, Junction City, WI (US)

(72) Inventors: Matthew Stefan, Junction City, WI (US); Jonathan Schultz, Tontitown, AR (US)

(21) Appl. No.: 19/056,364

(22) Filed: Feb. 18, 2025

Related U.S. Application Data
(60) Provisional application No. 63/554,771, filed on Feb. 16, 2024.

(51) Int. Cl. A01K 83/06

(52) U.S. Cl. CPC A01K 83/064

(57) ABSTRACT

The present subject matter discloses systems and methods for a fishing rig related to hover strolling techniques. Specifically, the rig disclosed herein includes a rig body, an eyelet, and a hook. The rig body includes a first end and a second end. The eyelet is located on the rig body spaced from the first end and extends in a first direction. The hook extends from the second end of the rig body and includes a proximal end and a distal end. The distal end extends from the rig body in the first direction.

### CROSS-REFERENCE TO RELATED APPLICATIONS

This application claims the benefit of priority to U.S. Provisional Patent Application No. 63/554,771 filed on Feb. 16, 2024, the entire contents of which is incorporated herein by reference.

### BACKGROUND OF THE INVENTION

Hover strolling is a known fishing technique used to catch suspended fish, such as bass, in pressurized bodies of water. This technique involves suspending the bait within a water column to control the vertical depth of the bait in the water. Once suspended, gliding motions are preferred as the fish targeted by hover strolling techniques are fish that are less receptive to fast-moving bait or bait that sinks quickly in water.

There are at least two common problems with hover strolling. First, hover strolling is typically performed using a highly buoyant baitfish-style soft plastic lure through which a 90° hook is inserted. The depth at which the lure stays suspended in the water is influenced by the weight of the lure and can be adjusted by adding a nail weight to the front of the lure achieve the desired flotation depth. However, using a nail weight moves the center of gravity of the lure and focuses the weight at the front end of the bait, causing the bait to fall head first down the water column instead of providing a more natural horizontal bait presentation that aids in performing a preferred slow gliding motion, a spiraling motion, or even a darting motion in the water.

Second, it can be difficult to maintain the bait on the hook, as the hook is not secure within the bait. Once the hook separates from the bait, the bait is often lost in the water. This problem can create frustration in those who fish as there is variability in efficacy of the technique.

There is no successful solution on the market that addresses these concerns. Accordingly, there is a need for a secure rig which enables a user to utilize hover strolling techniques without losing the bait and rig bodies, as described and claimed herein.

### BRIEF SUMMARY OF THE INVENTION

The present subject matter discloses systems and methods for a fishing rig related to hover strolling techniques. Specifically, the rig disclosed herein includes a hook, a rig body, a weed guard, and an eyelet having specific characteristic and being configured in a specific relationship to each other.

In one example embodiment, the fishing rig of the present disclosure includes a rig body including a first end and a second end, an eyelet located on the rig body spaced from the first end, and a hook extending from the second end of the rig body. The eyelet extends from the rig body in a first direction. The hook includes a proximal end and a distal end, and the distal end extends from the rig body in the first direction. In some embodiments, the rig body includes a first portion between the first end and the eyelet, wherein the first portion is tapered.

A surface of the rig body may be shaped specifically to increase the engagement forces between the rig and the bait into which it is inserted. For example, the rig body may include: a stepped, frustoconical shape; a cylindrical spiral screw shape; or a ribbed shape. In some embodiments, the shape of the rig body is configured to increase at least one of friction and normal force between the rig body and the bait.

The fishing rig may include a weed guard extending from the rig body, wherein the weed guard has a proximal end and a distal end, the proximal end being located on the rig body adjacent to the eyelet. The weed guard extends from the rig body in the first direction and forms an angle with a longitudinal axis of the rig body.

In light of the disclosure herein and without limiting the disclosure in any way, in a first aspect of the present disclosure, which may be combined with any other aspect listed herein unless specified otherwise, a fishing rig for use with a bait comprises a rig body having a first portion, a second portion, and a third portion. The second portion has a saw-toothed surface. The fishing rig further includes an eyelet affixed to the first portion of the rig body, the eyelet defining an aperture and a hook affixed to the third portion of the rig body.

In another aspect of the present disclosure, which may be combined with any other aspect listed herein unless specified otherwise, the first portion is tapered.

In another aspect of the present disclosure, which may be combined with any other aspect listed herein unless specified otherwise, the rig body is configured to increase friction and secure the attachment between the rig body and the bait.

In another aspect of the present disclosure, which may be combined with any other aspect listed herein unless specified otherwise, the rig body is comprised of at least one of tungsten, steel, alloyed steel, vanadium, brass, and lead.

In another aspect of the present disclosure, which may be combined with any other aspect listed herein unless specified otherwise, the fishing rig further comprises a weed guard adjacent to the eyelet, the weed guard having a proximal end and a distal end, the proximal end being affixed to the second portion of the rig body, the weed guard sloping from the proximal end towards the distal end from the second portion of the rig body towards the third portion of the rig body.

In another aspect of the present disclosure, which may be combined with any other aspect listed herein unless specified otherwise, the weed guard is a twisted shape.

In another aspect of the present disclosure, which may be combined with any other aspect listed herein unless specified otherwise, the hook is a barbed hook.

In another aspect of the present disclosure, which may be combined with any other aspect listed herein unless specified otherwise, the bait is one of a fluke style bait, a flat tail worm bait, a craw bait, a soft stick bait, a soft jerkbait, a paddle tail swimbait, and a pin tail swimbait.

In another aspect of the present disclosure, which may be combined with any other aspect listed herein unless specified otherwise, a method for rigging a fishing rig to a bait includes the steps of inserting a distal end of a hook of the fishing rig into the bait at a first point, wherein the first point is located at a first distance from a first end of the bait, threading the hook and the rig body through the bait, pushing the distal end of the hook out of the bait at a second location, wherein an eyelet of the rig body is positioned adjacent to the first point, and positioning a first end of the rig body opposite the hook within the bait between the first point and the first end of the bait.

In another aspect of the present disclosure, which may be combined with any other aspect listed herein unless specified otherwise, the step of positioning the first end of the rig body comprises pulling the first end of the bait away from the rig body and inserting the first end of the rig body into the bait between the first point and the first end of the bait.

In another aspect of the present disclosure, which may be combined with any other aspect listed herein unless specified otherwise, the eyelet and the distal end of the hook are outside of the bait after positioning the first end of the rig body within the bait.

In another aspect of the present disclosure, which may be combined with any other aspect listed herein unless specified otherwise, the rig body includes a first portion between the first end of the rig body and the eyelet, and wherein the first portion is tapered or otherwise shaped to facilitate a more secure engagement with the lure.

In another aspect of the present disclosure, which may be combined with any other aspect listed herein unless specified otherwise, the rig body is shaped to increase at least one of friction and normal force between the rig body and the bait.

In another aspect of the present disclosure, which may be combined with any other aspect listed herein unless specified otherwise, a weed guard extending from the rig body adjacent to the eyelet extends from the bait after positioning the first end of the rig body within the bait.

In another aspect of the present disclosure, which may be combined with any other aspect listed herein unless specified otherwise, a method for rigging a fishing rig to a bait includes the steps of providing the fishing rig having a rig body having a first portion, a second portion, and a third portion, the first portion being affixed to an eyelet, the third portion being affixed to a hook; providing the bait, the bait being pliable; inserting the hook into the bait when the rig body is parallel to a length of the bait; threading the hook through the bait such that the bait deforms, creating an internal surface within the bait; pushing the rig body through the internal surface of the bait; pushing the hook out of the bait; and pulling the bait over the first portion of the rig body creating a secure engagement of the fishing rig within the bait.

In another aspect of the present disclosure, which may be combined with any other aspect listed herein unless specified otherwise, the eyelet and a portion of the hook are exposed after pulling the bait over the first portion of the rig body.

In another aspect of the present disclosure, which may be combined with any other aspect listed herein unless specified otherwise, the first portion is tapered.

In another aspect of the present disclosure, which may be combined with any other aspect listed herein unless specified otherwise, the rig body is configured to increase a secure engagement between the rig body and the bait.

In another aspect of the present disclosure, which may be combined with any other aspect listed herein unless specified otherwise, the rig body is comprised of at least one of tungsten, steel, alloyed steel, vanadium, brass, and lead.

In another aspect of the present disclosure, which may be combined with any other aspect listed herein unless specified otherwise, the fishing rig further comprises a weed guard adjacent to the eyelet, the weed guard having a proximal end and a distal end, the proximal end being affixed to the second portion of the rig body, the weed guard sloping from the proximal end towards the distal end from the second portion of the rig body towards the third portion of the rig body.

In another aspect of the present disclosure, which may be combined with any other aspect listed herein unless specified otherwise, the weed guard is a twisted shape.

In another aspect of the present disclosure, which may be combined with any other aspect listed herein unless specified otherwise, the hook is a barbed hook.

In another aspect of the present disclosure, which may be combined with any other aspect listed herein unless specified otherwise, the bait is one of a fluke style bait, a flat tail worm bait, a craw bait, a soft stick bait, a soft jerkbait, a paddle tail swimbait, and a pin tail swimbait.

An advantage of the methods and systems disclosed herein is that the rig securely engages with the bait to decrease the likelihood of losing bait in the water.

A further advantage of the methods and systems disclosed herein is that, compared to prior methods and systems in which a nail weight was added to the front of the lure to adjust the weight of the lure, the center of gravity of the rig is shifted towards the middle of the bait to enable a smoother descent into the water.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 is an isometric view of a hovering, strolling fishing rig, according to an example embodiment of the present disclosure.

FIG. 2 is a right side elevation view of the fishing rig of FIG. 1, which is a mirror image of the left side elevation view.

FIG. 3 is an exploded right side elevation view of the fishing rig of FIG. 1.

FIGS. 4A-4E are right side elevation views of alternative embodiments of the fishing rig of FIG. 1, each embodiment having a varied number of body segments.

FIG. 5 is a front elevation view of the fishing rig of FIG. 1.

FIG. 6 is a plan view of the fishing rig of FIG. 1.

FIGS. 7A-7I illustrate the process of loading bait onto the fishing rig of FIG. 1.

FIG. 8 is an isometric view of the fishing rig of FIG. 1 inserted into a worm style bait.

FIG. 9 is a front elevation view of the fishing rig of FIG. 1 inserted into a fluke style bait, according to an example embodiment of the present disclosure.

FIG. 10 is a flow chart illustrating the bait insertion process, according to an example embodiment of the present disclosure.

FIG. 11 is a flow chart illustrating the bait insertion process, according to another example embodiment of the present disclosure.

### DETAILED DESCRIPTION OF THE INVENTION

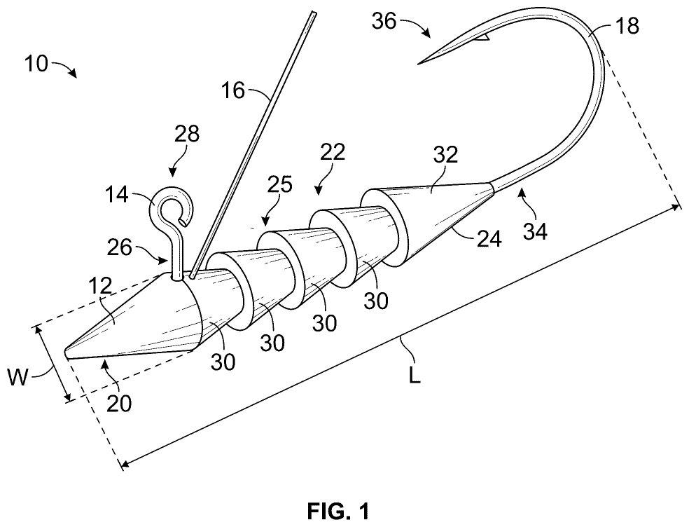

The present disclosure provides for a hovering, strolling fishing rig related to hover strolling techniques. Referring to FIGS. 1-6, the rig 10 disclosed herein includes a rig body 12, an eyelet 14, an optional weed guard 16, and a hook 18.

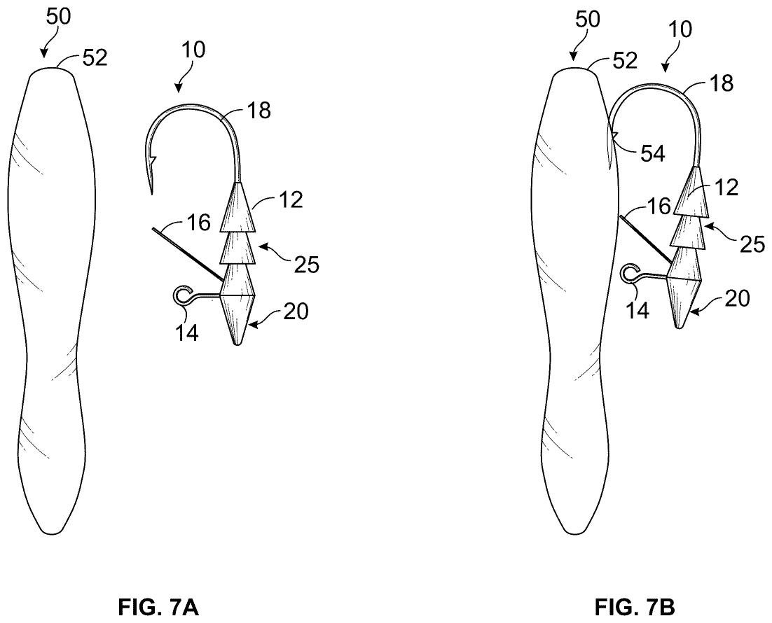

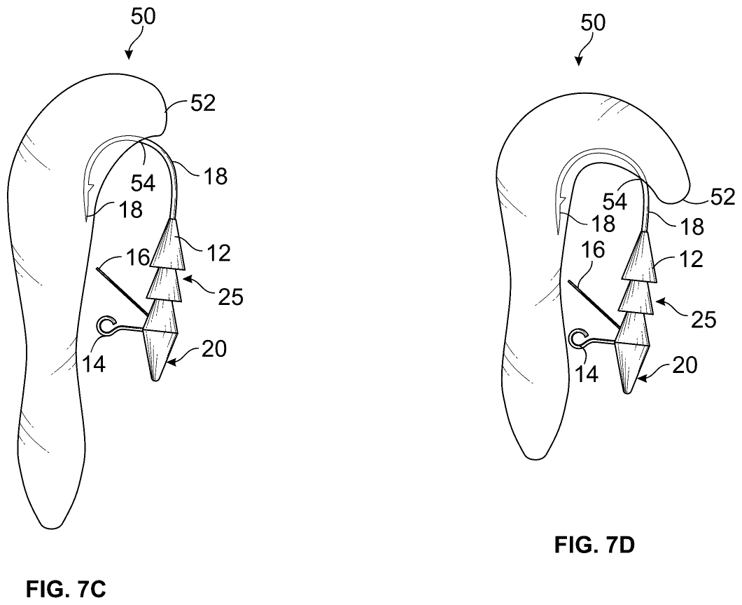

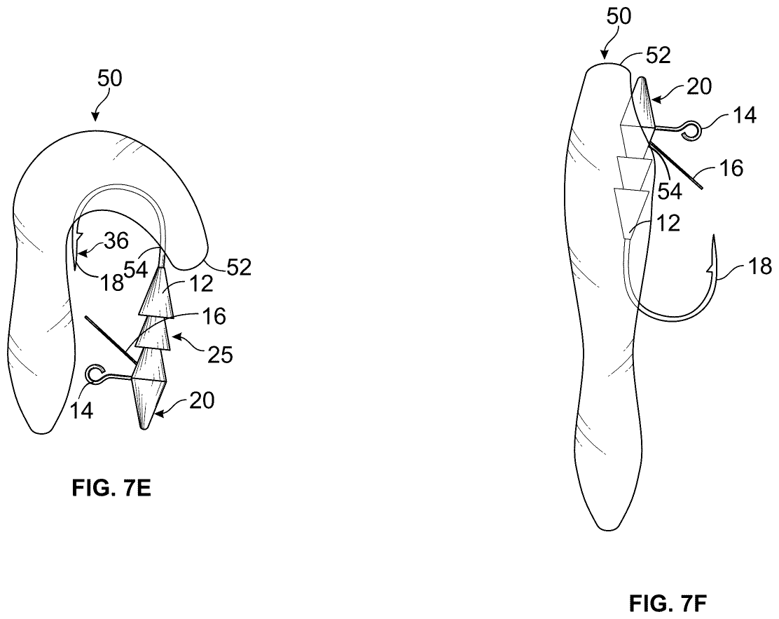

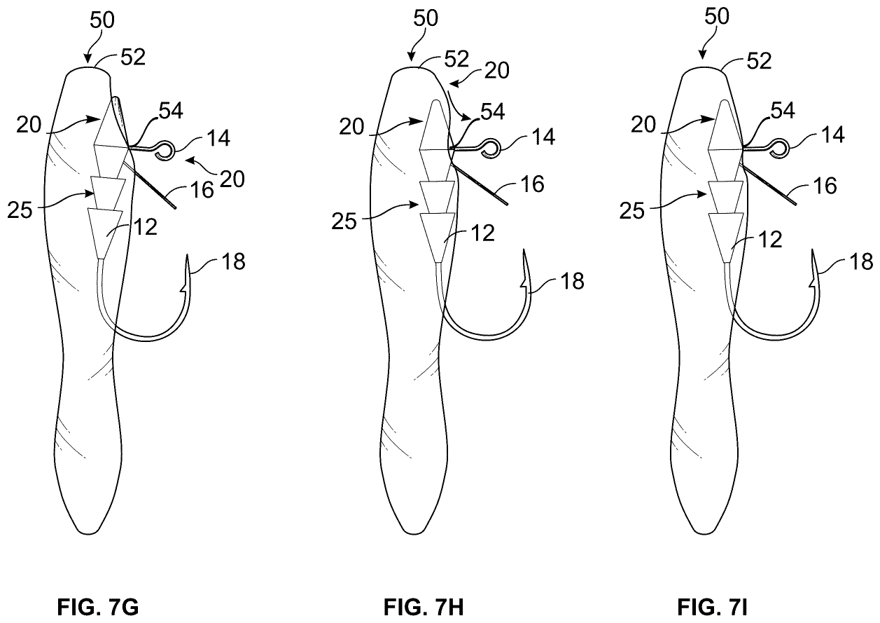

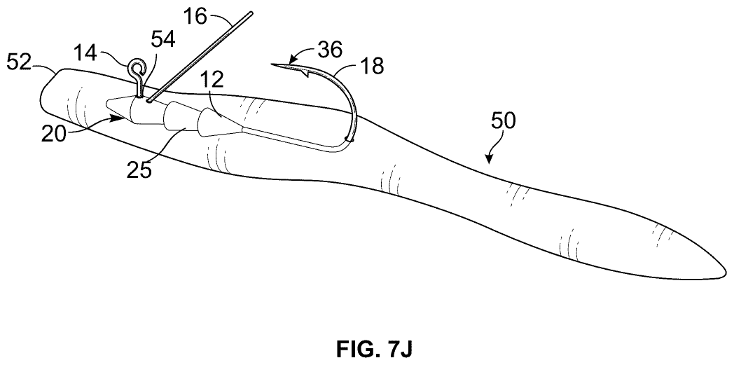

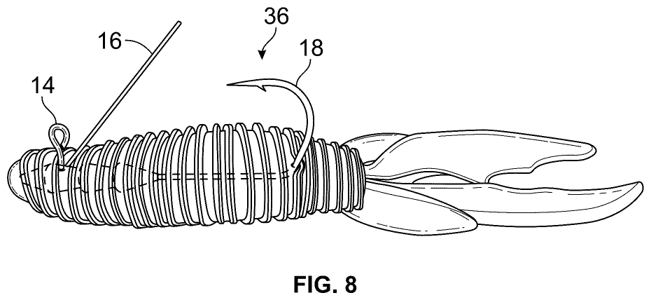

The rig 10 is designed to be inserted into a bait 50 (FIGS. 7-9). As used herein, the term “bait” may refer to live baits or artificial lures. “Bait” includes any bait or lure into which at least a portion of the rig body 12 may be inserted. In some embodiments, the term bait or lure may refer to fluke style baits, flat tail worm baits, craw baits, soft stick baits, soft jerkbaits, paddle tail swimbaits, or pin tail swimbaits. It will be appreciated that the identified baits are purely exemplary and other types of baits may be utilized with the rig 10.

As the rig 10 is designed to be inserted into a bait 50, the rig body 12 may be any material suitable to exert a force against the bait 50 when inserted into the bait 50. The rig body 12 is configured to secure an engagement between the rig body and the bait 50. As one such example, the rig body 12 may be comprised of tungsten, steel, alloyed steel, vanadium, brass, lead, or other such dense materials as known to a person having ordinary skill in the art. In other embodiments, the rig body 12 may be comprised of more than one material.

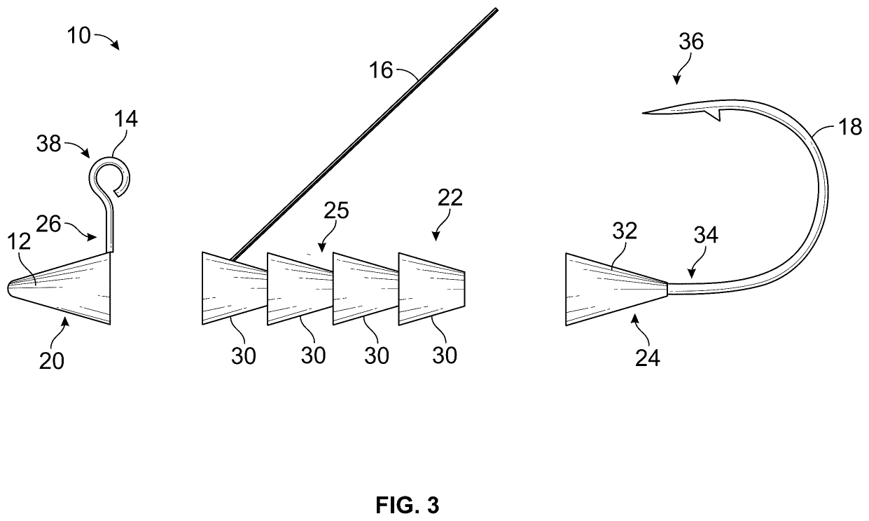

In some embodiments, the rig body 12 includes opposing first and second ends 21, 23 along a length or longitudinal axis thereof. In some embodiments, the rig body 12 includes a first portion 20, a second portion 22, and a third portion 24. FIG. 3 illustrates an exploded view of the rig 10 to clarify each of the first portion 20, second portion 22, and third portion 24. In a preferred embodiment, the rig body 12 is a single unified member and, therefore, the exploded view is not representative of the various portions actually being separable. However, while in some embodiments, the first, second, and third portions 20, 22, 24 are integral with one another, in other embodiments, one or more of the portions 20, 22, 24 are separate and secured to one another.

The first portion 20 is designed to create a secure engagement of the rig 10 within bait 50 due to the penetration of the first end 21 of the rig 10 into bait 50 when the bait 50 is loaded on the rig 10. In some embodiments, the first portion 20 may be a tapered head such as that shown in FIGS. 1-6, with the narrowest region on a front end of the portion 20. This conical head shape allows for the front portion 20 to be inserted into soft bait 50 to fully secure the rig 10 within the bait 50 as described in greater detail below. In other embodiments, the first portion 20 may include other shapes in addition to those illustrated. In still further embodiments, the first portion 20 may include additional features to enable easy application of the bait 50, such as a pointed end.

The first portion 20 also adds mass to the rig 10 in front of the eyelet 14. The mass skews the center of mass of the rig 10 towards the first portion 20. The weight distribution of the rig 10 may be varied depending on where the weight of the rig 10 is concentrated between the first, second, and third portions 20, 22, and 24 and can be intentionally designed to promote a slow gliding motion, a spiraling motion, or even a darting motion in the water to attract fish, depending on how the weight is balanced. The weight distribution may result from enlarging one or more of the first, second, and third portions 20, 22, and 24 relative to each other, the use of a heavier or lighter materials in any of the first, second, and third portions 20,22, and 24, or other suitable means.

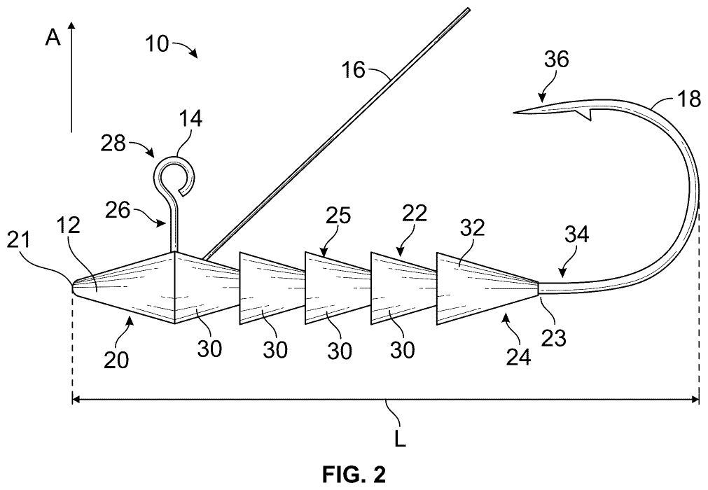

As shown in FIG. 2, the eyelet 14 extends from the rig body 12 in a first direction A to allow for a fishing line to be tied to the rig 10. In one example embodiment, the eyelet 14 is located on the first portion 20 of the rig body 12. In the illustrated embodiment, the eyelet 14 is positioned on an edge of the first portion 20 of the rig body 12 near the second portion 22. The eyelet 14 includes a bottom end 26 affixed to or formed integrally with the rig body 12 and a top end 28 having a curved shape to define an aperture. In some embodiments, the top end 28 of the eyelet 14 may form a fully enclosed aperture. In other embodiments, the top end 28 of the eyelet 14 may form a circular shape defining an aperture having a gap along the circumference as illustrated. The eyelet 14 can be any material capable of holding its shape. As one such example, the eyelet 14 may be a metal such as high-carbon steel, steel alloyed with vanadium or stainless steel, lead, tungsten, or other such materials as known to a person having ordinary skill in the art.

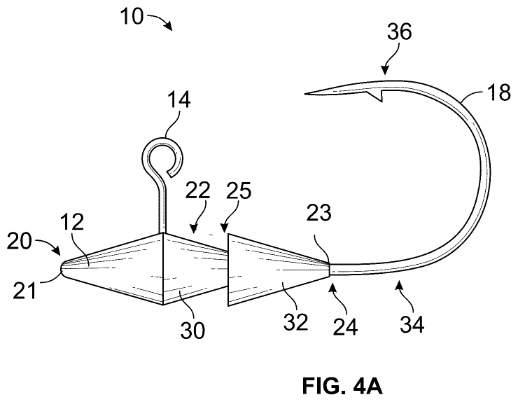

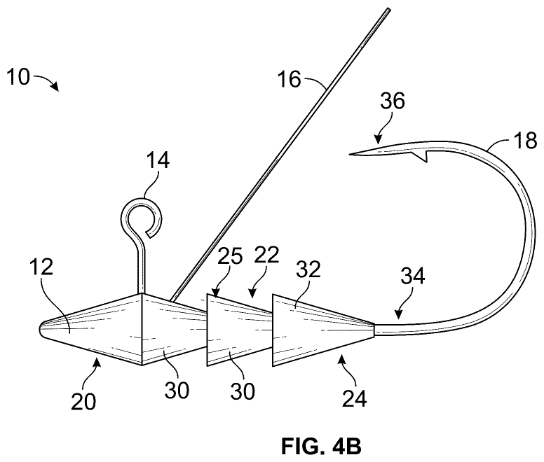

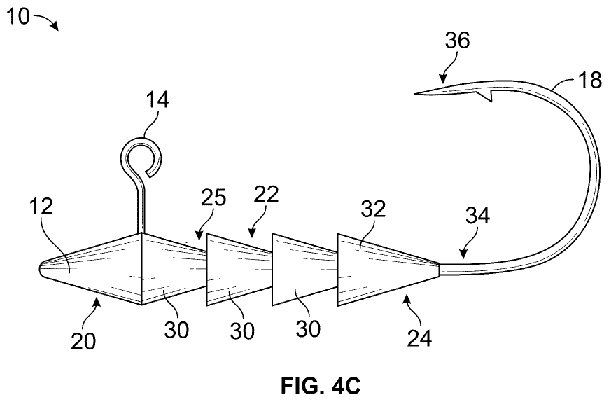

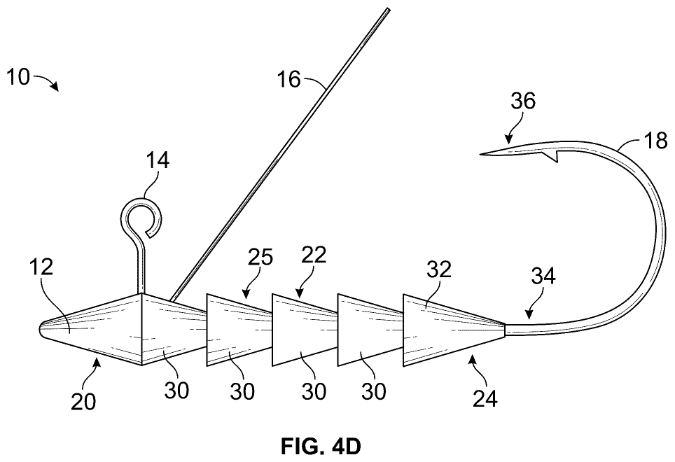

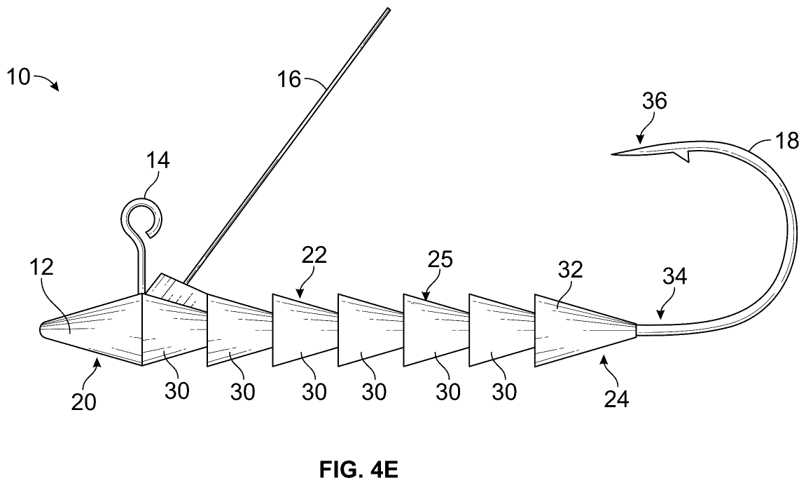

The rig body 12 further includes a second portion 22 having segments 30 to increase the weight of the rig 10 and assist in creating a secure engagement of the rig 10 within the bait 50. As shown in FIGS. 4A-4E, the number of segments may vary. FIG. 4A illustrates a rig 10 with one segment 30. FIG. 4B illustrates a rig 10 with two segments 30. FIG. 4C illustrates a rig 10 with three segments 30. FIG. 4D illustrates a rig 10 with four segments 30. FIG. 4E illustrates a rig 10 with six segments 30. Assuming a consistent weight for each segment, the number of segments 30 included in the second portion 22 of the rig body 12 may help to determine the gliding motion of the rig 10 and bait 50 within the water as lighter rigs 10 (such as the rig 10 of FIG. 4A) may have more erratic motion when compared to rigs 10 with more segments 30 (such as the rig 10 of FIG. 4E). Additionally, rigs 10 having greater weight may be used in water columns that have heavier brush and debris. Any number of segments 30 may be used, with the length of the intended bait 50 guiding the maximum number of segments 30 that may be preferred.

The segments 30 may be comprised of the same material as the rest of the rig body 12, different materials than the rest of the rig body 12, or each segment 30 may be comprised of different materials entirely. The segments 30 may be any shape including spheres, cones, cylinders, cubes, or may resemble other three-dimensional shapes, though some shapes may be preferred to more securely engage the bait 50 and the rig 10. Alternatively, the segments 30 may differ in size from one another.

The segments 30 may form a shape 25 on the rig body 12. The shape 25 may be: a stepped, frustoconical shape, a cylindrical spiral screw shape, a ridged or ribbed shape, and/or any other shape. In some embodiments, the shape 25 is designed to increase at least one of friction and normal force between the rig body 12 and the bait 50. In one embodiment, the segments 30 form partial cones or frustoconical portions adjacent one another to create a saw-toothed side profile that can be seen in FIGS. 2-3. In this embodiment, the saw-toothed surface comprises all segments 30. The frustoconical portions create surfaces or teeth which engage the interior of the bait 50 to secure the rig 10 in the bait 50. In this embodiment, the frustoconical portions are oriented such that a base with the greatest diameter is closer to the first portion 20 on each segment 30 relative to an end with the narrowest diameter. This orientation ensures that as the rig 10 moves through the water in the intended direction (i.e. with the first portion 20 leading the rig 10 through the water), the part of each segment 30 with the largest surface area in the direction of motion engages the bait 50. The normal and frictional forces generated between the bait 50 and the segments 30 retains the bait 50 on the rig body 12 while moving.

In the embodiment illustrated in FIG. 1, a weed guard 16 is affixed to the segment 30 nearest the first portion 20 of the rig body 12. The weed guard 16 is a rod that extends diagonally from the second portion 22 of the rig body 12 towards the hook 18, with the rod extending above the hook 18. The weed guard 16 includes a proximal end 17 on the rig body 12 and a distal end 19 extending in the first direction A away from the rig body 12 and forming an angle with the longitudinal axis L of the rig body 12. In some embodiments, the proximal end 17 of the weed guard 16 is located on the rig body 12 adjacent to the eyelet 14. The weed guard 16 may be disposed such that a distance between the distal end 19 of the weed guard 16 and the longitudinal axis L of the rig body 12 is greater than a distance between the distal end 36 of the hook 18 and the longitudinal axis L of the rig body 12.

During use, the weed guard 16 catches brush and debris in the water and blocks the hook 18 to prevent the hook 18 from becoming stuck in the debris. The weed guard 16 may create a surface for brush and debris particles to be dispersed before contacting the hook 18, thus ensuring that the hook 18 does not become entangled with brush or debris.

The weed guard 16 may be a rod of any material known to those having ordinary skill in the art. In some embodiments such as those illustrated in FIGS. 4B, 4D, and 4E, the weed guard 16 has a spiral shape. In embodiments where the weed guard 16 has a spiral configuration, the spiral may bias the brush and debris to move along the length of the weed guard 16 and away from the other rig 10 components as the rig 10 moves through water. In this way the weed guard 16 may act as a sort of corkscrew to disperse the brush and debris. In other embodiments such as those illustrated in FIGS. 4A and 4C, the rig 10 does not include a weed guard. It should be understood that the weed guard 16 may be included or excluded from any embodiment without deviating from the scope of the present disclosure, and that figures which exclude the weed guard 16 are not intended to limit the scope of the embodiment in such figures.

Referring to FIGS. 1 and 2, the third portion 24 of the rig body 12 includes a tail 32 that connects to a proximal end 34 of the hook 18. In some embodiments, the tail 32 may taper such that a width of the tail 32 is approximately equal to a width of the hook 18 at the point of connection between the rig body 12 and the hook 18. In some embodiments, the proximal end 34 of the hook 18 may be coupled to the rig body 12 through the use of adhesives glues such as epoxies or contact cements or through mechanical coupling. It should be appreciated that the identified adhesives and coupling mechanisms are exemplary and other adhesives and coupling mechanisms may be added or omitted in other embodiments of the rig 10. In other embodiments, the hook 18 may be formed integrally with the tail 32.

In some embodiments, the hook 18 is a “U”-shaped, cylindrical hook including the proximal end 34 on the rig body 12 and a distal end 36 that is sharply pointed. The hook 18 can be any material suitable to pierce a fish's mouth and be pulled by the user's rod. As one such example, the hook may be a metal such as high-carbon steel, steel alloyed with vanadium or stainless steel, lead, or tungsten. In some embodiments, the second end 36, which is intended to pierce the side of the fish's mouth, may be a barbed hook as shown in the illustrated embodiments. In further embodiments, the second end 36 may include two or more points. Other embodiments are also contemplated which may incorporate different types of hooks.

As shown in the illustrated embodiments, the eyelet 14 and the distal end 34 of the hook 18 extend in the direction A from the longitudinal axis L of the rig body 12. In some embodiments, the distal end 18 of the weed guard 16 is positioned at a distance from the longitudinal axis L of the rig body 12 greater than a distance between the distal end 36 of the hook 18 and the longitudinal axis L of the rig body 12.

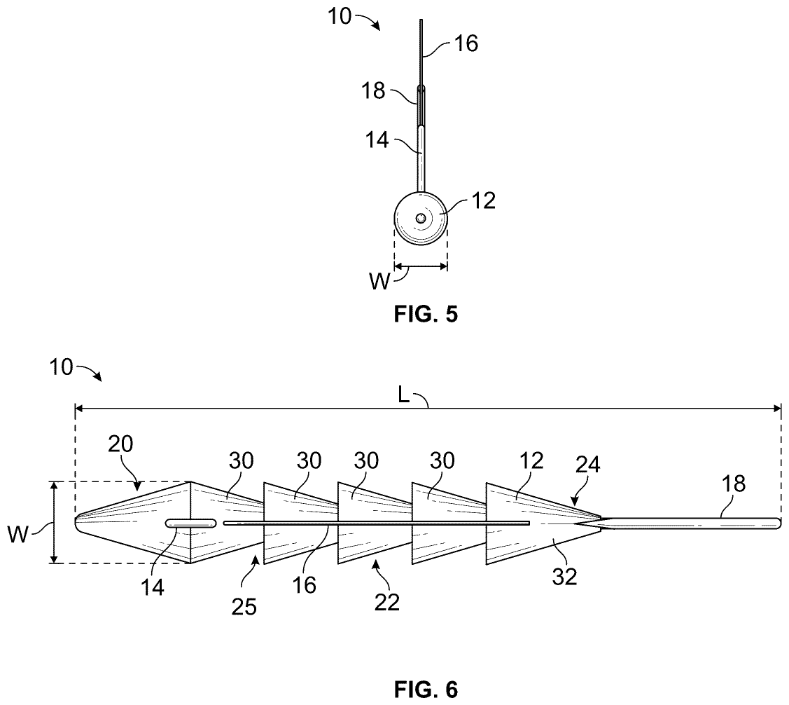

In some embodiments, the eyelet 14, weed guard 16, and hook 18 are located within the same plane parallel to direction L as shown in FIG. 6. As shown in FIG. 5, when viewed from a front side, the eyelet 14, weed guard 16, and hook 18 are affixed to the rig body 12 at the same point along a width W of the rig body 12.

FIGS. 7A-7I illustrate a process for inserting the rig 10 into bait 50. Because the insertion of the rig 10 internally deforms the bait 50, the rig 10 can be secured within the bait 50. Inserting the rig 10 into a pliable bait 50 creates a compressive force within the bait 50 that helps to facilitate a secure engagement of the rig 10 within the bait 50.

FIG. 7A illustrates the rig 10 and bait 50 prior to insertion. Before inserting the proximal end 32 of the hook 18 into the bait 50, the user determines a first point 54 at which the eyelet 14 will extend from the bait 50 after insertion in order to allow sufficient space between the eyelet 14 and a front end 52 of the bait 50 for the first portion 20 of the rig 10.

In the first step shown in FIG. 7B, the user inserts the hook 18 of the rig 10 into the bait 50 at the first point 52. Additionally, the second end 36 of the hook 18 may be near parallel to the bait 50 upon insertion. FIG. 7C illustrates the second end 36 of the hook 18 being further pushed along the length of the bait 50.

As the second end 36 of the hook 18 continues to be pushed into the bait 50, the bait 50 is threaded along the curvature of the hook 18 from the second end 36 to the first end 34 as shown in FIG. 7D. The rig body 12 travels along the path created by the hook 18. Since the bait 50 is pliable, the user curves the bait 50 such that the second end 36 of the hook 18 does not pierce through the bait 50 as the bait 50 is manipulated. Once the hook 18 is inserted at least the length of the rig body 12 through the bait 50 such that the eyelet 14 is positioned at the first point 54, the user pushes the second end 36 of the hook 18 out of the bait 50 as shown in FIG. 7E.

FIG. 7F illustrates the rig body 12 on the bait 50 after pushing the second end 36 of the hook 18 out of the bait 50. As the rig body 12 is pulled through the bait 50, the bait 50 deforms and creates an internal surface that engages with the rig 10. The user pulls the rig body 12 through the internal surface of the bait 50 until the second portion 22 and third portion 24 of the rig body 12 are mostly inserted into the bait 50. At this point, the first portion 20 of the rig body 12, the eyelet 14, and the weed guard 16 remain outside of the bait 50.

The user then positions the first end 21 of the rig body 12 opposite the hook 18 within the bait 50 between the first point 54 and the front end 52 of the bait 50 as shown in FIGS. 7G-7I. To insert the first end 21 of the rig body 12 in the bait 50, the user grasps the front end 52 of the bait 50 near the first portion 20 of the rig body 12, as shown in FIG. 7G and stretches the front end 52 of the bait 50 50 away from the rig body 12 in order to receive the first end 21 of the rig body 12. The user then inserts the first end 21 of the rig body 12 into the bait 50 by pulling the bait 50 over the first portion 20 of the rig body 12 as shown in FIGS. 7H and 7I.

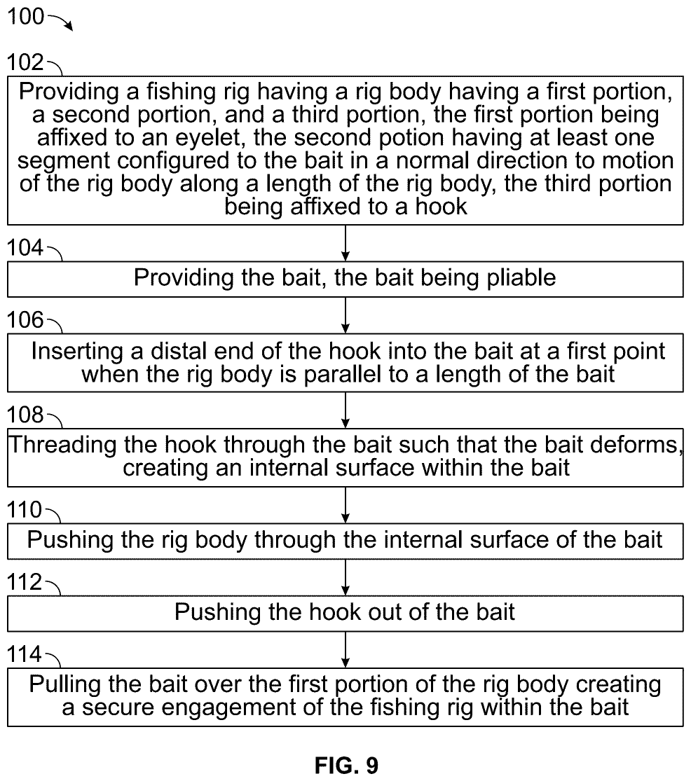

FIGS. 8 and 9 illustrate the fishing rig 10 when properly inserted into the bait 50. FIG. 8 depicts the rig 10 inserted into a flat tail worm bait 50. FIG. 9 depicts the rig 10 inserted into a fluke style bait 50. When properly rigged, only the rig body 12 and the first end 34 of the hook 18 are inside the bait 50. This is particularly valuable for fishing as fish may be deterred by certain shapes or materials unknown to them. Instead, with only the eyelet 14, the weed guard 16, and the hook 18 unobstructed, fish may be more likely to approach the rig 10 when in use.

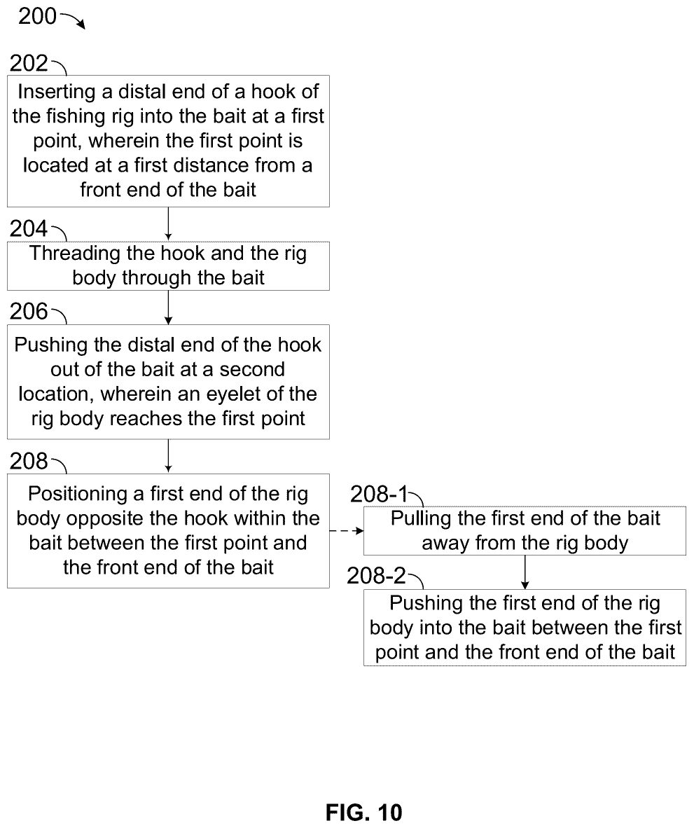

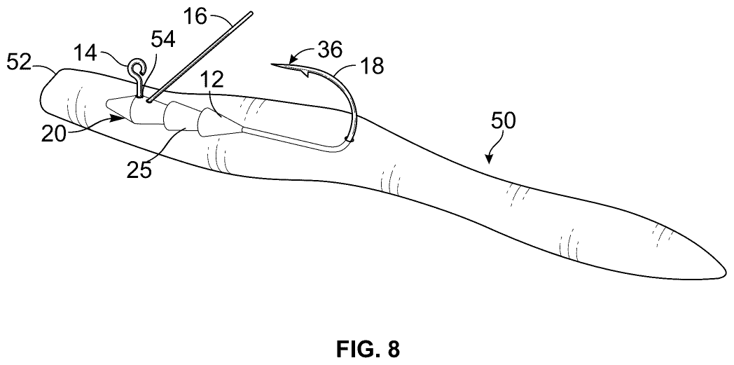

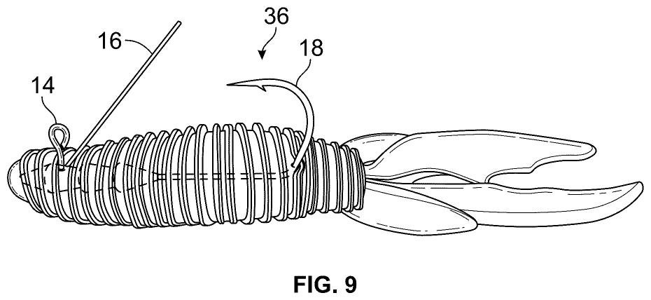

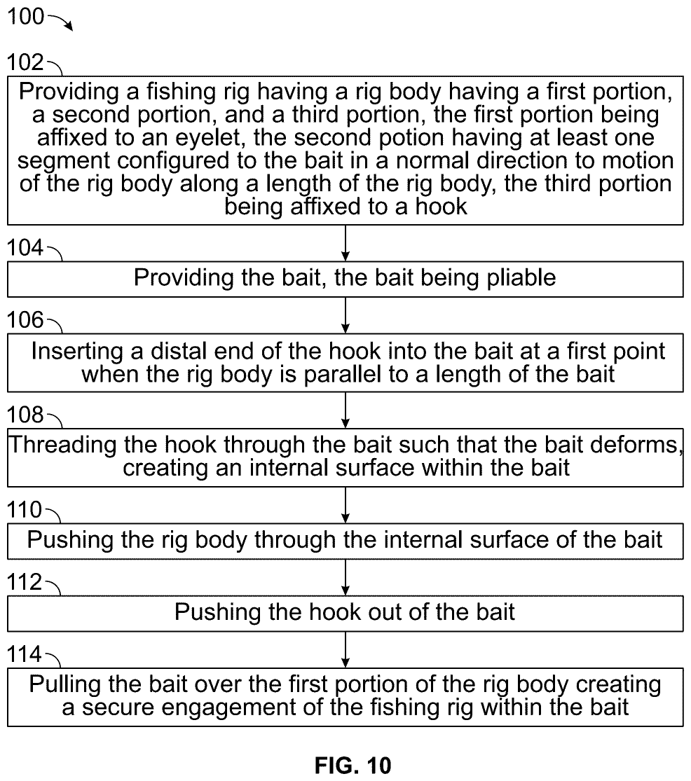

The process 100 for inserting the rig into bait 50 may be summarized by the flowchart shown in FIG. 10. In a first step 102, a fishing rig having a rig body having a first portion, a second portion, and a third portion is provided. The first portion is affixed to an eyelet. The second portion includes at least one segment configured to engage the bait 50 in a normal direction to motion of the rig body along a length of the rig body. The third portion is affixed to a hook. In a second step 104, the bait 50 is provided. The bait 50 is pliable such that it may be manipulated by a user. In a third step 106, the hook is inserted into the bait 50 when the rig body is parallel to a length of the bait 50. In a fourth step 108, the hook is threaded through the bait 50 such that the bait 50 deforms and creates an internal surface within the bait 50. In a fifth step 110, the rig body is pushed through the internal surface of the bait 50. In a sixth step 112, the hook is pushed out of the bait 50. In a seventh step 114, the bait 50 is pulled over the first portion of the rig body creating a secure engagement of the fishing rig within the bait 50. It will be appreciated that the order of the steps is purely exemplary and other arrangements of the above-listed steps, including an omission of one or multiple steps, may be used and known to a person having ordinary skill in the art.

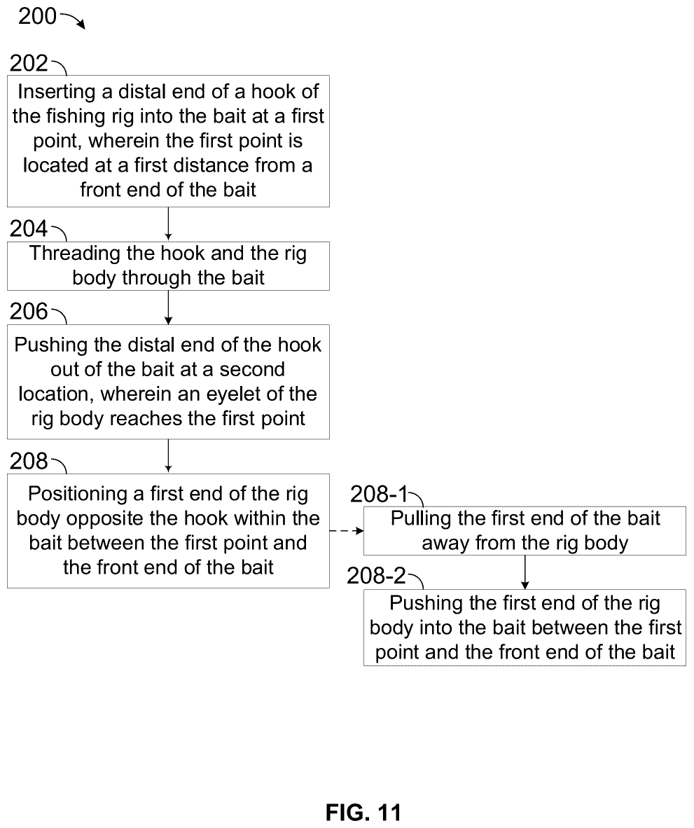

An alternative way to describe the insertion of the rig of the present disclosure into the bait by the process 200 may be summarized by the flowchart shown in FIG. 11. The flowcharts in FIGS. 10 and 11 are not intended to be considered different methods, but rather different descriptions of the same method. In a first step 202, a distal end of a hook of the fishing rig is inserted into the pliable bait at a first point, wherein the first point is located at a first distance from a front end of the bait. In a second step 204 the hook and rig body are threaded through the bait. In a third step 206 the distal end of the hook is pushed out of the bait at a second location until an eyelet of the rig body approaches the first point. At a fourth step 208 a first end of the rig body opposite the hook is positioned within the bait between the first point and the front end of the bait. The fourth step 208 may itself comprise substeps. Such substeps may include a first substep 208-1 where the first end of the bait is pulled away from the rig body, and a second substep 208-2 where the first end of the rig body is pushed into the bait between the first point and the front end of the bait. It will be appreciated that the order of the steps is purely exemplary and other arrangements of the above-listed steps, including an omission of one or multiple steps, may be used and known to a person having ordinary skill in the art.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method may be provided based on various combinations of the features and functions from the subject matter provided herein.

We claim:

1. A fishing rig for use with a bait, the fishing rig comprising:
a rig body including a first end and a second end;
an eyelet located on the rig body spaced from the first end, wherein the eyelet extends from the rig body in a first direction; and
a hook extending from the second end of the rig body, wherein the hook includes a proximal end and a distal end, and wherein the distal end extends from the rig body in the first direction.

2. The fishing rig of claim 1, wherein the rig body includes a first portion between the first end and the eyelet, wherein the first portion is tapered.

3. The fishing rig of claim 1, wherein a shaped portion of the rig body located between the eyelet and the second end increases a strength of engagement between the rig body and the bait into which it is inserted.

4. The fishing rig of claim 3, wherein the shaped portion of the rig body includes one or more of: a stepped, frustoconical shape; a cylindrical spiral screw shape; and a ridged or ribbed shape.

5. The fishing rig of claim 3, wherein the shaped portion of the rig body is configured to increase at least one of friction and normal force between the rig body and the bait.

6. The fishing rig of claim 1, further comprising a weed guard extending from the rig body, wherein the weed guard has a proximal end and a distal end, the proximal end being located on the rig body adjacent to the eyelet.

7. The fishing rig of claim 6, wherein the weed guard extends from the rig body in the first direction and forms an angle with a longitudinal axis of the rig body.

8. The fishing rig of claim 7, wherein a distance between the distal end of the weed guard and the longitudinal axis of the rig body is greater than a distance between the distal end of the hook and the longitudinal axis of the rig body.

9. The fishing rig of claim 6, wherein the weed guard has a spiral shape.

10. The fishing rig of claim 1, wherein the bait is one of a fluke style bait, a flat tail worm bait, a craw bait, a soft stick bait, a soft jerkbait, a paddle tail swimbait, and a pin tail swimbait.

11. A method for rigging a fishing rig including a rig body, a hook, and an eyelet to a bait, the method comprising:
inserting a distal end of the hook into the bait at a first point, wherein the first point is located at a first distance from a front end of the bait;
threading the hook and the rig body through the bait;
pushing the distal end of the hook out of the bait at a second location until the eyelet approaches the first point; and
positioning a first end of the rig body opposite the hook within the bait between the first point and the front end of the bait.

12. The method of claim 11, wherein the step of positioning the first end of the rig body comprises:
pulling the first end of the bait away from the rig body; and
inserting the first end of the rig body into the bait between the first point and the front end of the bait.

13. The method of claim 11, wherein the eyelet and the distal end of the hook are outside of the bait after positioning the first end of the rig body within the bait.

14. The method of claim 11, wherein the rig body includes a first portion between the first end of the rig body and the eyelet, and wherein the first portion is tapered.

15. The method of claim 11, wherein the rig body comprises a portion of the rig body shaped to increase at least one of friction and normal force between the rig body and the bait.

16. The method of claim 11, wherein the fishing rig also includes a weed guard extending from the rig body adjacent to the eyelet such that the weed guard extends from the bait after positioning the first end of the rig body within the bait.
